(19) United States
(12) Patent Application Publication
(10) Pub. No.: US 2022/0408968 A1
(43) Pub. Date: Dec. 29, 2022

(54) FOOD COOKING DEVICE

(71) Applicant: NINGBO AGSUN PRODUCTS,INC., CIXI (CN)

(72) Inventors: Xuefei Mao, CIXI (CN); Zhenzhou Xie, CIXI (CN); Xianghua Liu, CIXI (CN)

(73) Assignee: NINGBO AGSUN PRODUCTS,INC., CIXI (CN)

(21) Appl. No.: 17/900,896

(22) Filed: Sep. 1, 2022

(30) Foreign Application Priority Data
Jul. 20, 2022 (CN) 202221889916.3

(51) Int. Cl. A47J 37/07

(52) U.S. Cl. CPC A47J 37/0704; A47J 37/0786

(57) ABSTRACT

The disclosure provides a food cooking device which comprises a grill body and a rack body, where a food cooking cavity is disposed in the grill body, and the rack body is disposed in the food cooking cavity and located below food being cooked, the rack body comprises at least one net rack, the net rack comprises a plurality of bar-shaped pieces disposed spaced from each other, two adjacent bar-shaped pieces are connected by a connecting piece, one side of each of the bar-shaped pieces facing the food being cooked is formed with an oil guiding groove extending along a length direction thereof, the net rack is obliquely mounted in the food cooking cavity so that the oil guiding groove on each of the bar-shaped pieces is in an inclined state, and two ends of the oil guiding groove form a height difference.

### TECHNICAL FIELD

The disclosure pertains to the technical field of grills, and specifically pertains to a food cooking device.

### BACKGROUND

At present, barbecue grills are a commonly used food processing apparatus, and often used to grill various meat products, vegetables and other food. With the increasing improvement of people's living standards, barbecue grills are more and more widely used. During use of an existing grill, food is placed on a grilling net to perform grilling operations. However, in the process of grilling, residual grease on the grilling net easily drips onto a grill head pipe as a heat source, and the residual grease burns to generate thick smoke and other harmful substances, polluting the food, affecting taste and flavor of the food, and resulting in poor barbecue experience.

### SUMMARY

A purpose of the disclosure is to design a food cooking device in order to solve the above-mentioned technical deficiencies, which has the advantages of having a good oil guiding effect on grease, and to a certain extent, avoiding contamination of the food by oil smoke and improving barbecue experience.

In order to solve the above-mentioned technical problems, the technical scheme of the disclosure is as follows: a food cooking device which comprises a grill body and a rack body, where a food cooking cavity is disposed in the grill body, and the rack body is disposed in the food cooking cavity and located below food being cooked, the rack body comprises at least one net rack, the net rack comprises a plurality of bar-shaped pieces disposed spaced from each other, the bar-shaped pieces are respectively connected to each other by a connecting piece, one side of each of the bar-shaped pieces facing the food being cooked is formed with an oil guiding groove extending along a length direction thereof, the net rack is obliquely mounted in the food cooking cavity so that the oil guiding groove on each of the bar-shaped pieces is in an inclined state, and two ends of the oil guiding groove form a height difference.

Preferably, an end portion of the network rack located at a position of one end of each of the bar-shaped pieces is erected on a first step surface on the food cooking cavity by at least one first cushion block.

Preferably, an end portion of the net rack located at a position of the other end of each of the bar-shaped pieces is erected on a second step surface on the food cooking cavity by at least one second cushion block, and the first cushion block and the second cushion block have a height difference so that the net rack is in an inclined state after being mounted in the food cooking cavity.

Preferably, the connecting piece further comprises a first support bar, the first support bar is formed on the end portion of the net rack located at the position of one end of each of the bar-shaped pieces, and the at least one first block is formed on the first support bar.

Preferably, the connecting piece further comprises a second support bar, the second support bar is formed on the end portion of the net rack located at the position of the other end of each of the bar-shaped pieces, and the at least one second cushion block is formed on the second support bar.

Preferably, the connecting piece comprises a first connecting block, and the first connecting block is fixedly connected with two adjacent bar-shaped pieces.

Preferably, an outer wall of the bar-shaped piece located at the outermost side is formed with a second connecting block, and a position of the second connecting block corresponds to a position of the first connecting block.

Preferably, the grill body comprises an oil collecting rack for mounting the net rack, the second step surface is formed on the oil collecting rack, a height of the first cushion block is higher than a height of the second cushion block, and a bottom of the oil collecting rack is provided with an oil collecting groove disposed obliquely towards the net rack.

Preferably, a baffle is formed on a top surface of the oil collecting rack, and a side wall of the second support bar is provided with a spacer block abutting against the baffle.

Preferably, both sides of the oil collecting rack are provided with mounting plates abutting against end portions of the second support bar.

Compared with the prior art, the disclosure has the following beneficial effects: by disposing the first cushion block and the second cushion block in a height difference, the net rack mounted in the food cooking cavity is inclined, so that the oil guiding groove on each of the bar-shaped pieces is in an inclined state; when a user grills food on the net rack, grease on the net rack flows to the first support bar under the guidance of the oil guiding groove, producing good oil guiding effect on the grease, preventing excess grease from dripping onto a heat source through the net rack, and to a certain extent, avoiding contamination of the food by oil smoke and improving barbecue experience of users.

### BRIEF DESCRIPTION OF THE DRAWINGS

FIG. 1 is a structural schematic diagram of an embodiment;

FIG. 2 is a sectional view I of an embodiment;

FIG. 3 is a sectional view II of an embodiment;

FIG. 4 is a structural schematic diagram of a grill body;

FIG. 5 is an exploded view of a rack body; and

FIG. 6 is a structural diagram of a net rack.

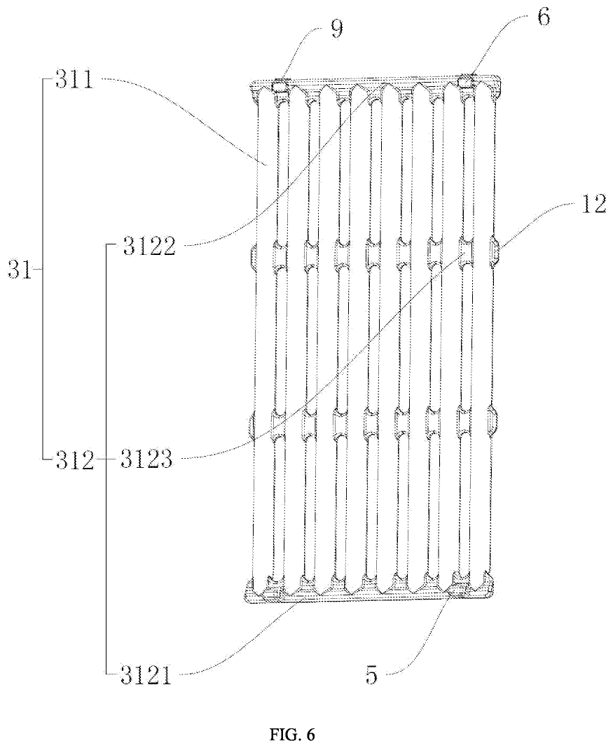

In the drawings: 1. grill body; 2. food cooking cavity; 3. rack body; 31. net rack; 311. bar-shaped piece; 312. connecting piece; 3121. first support bar; 3122. second support bar; 3123. first connecting block; 32, oil collecting rack; 4. oil guiding groove; 5. first cushion block; 6. second cushion block; 7. oil collecting groove; 8. baffle; 9. spacer block; 19. mounting rack; 10. mounting plate; 12. second connecting block; 13. Enclosure plate; 14, grill head pipe; 15. regulating valve; 16. oil collecting tray; 17. oil outlet; 18. oil collecting box.

### DESCRIPTION OF THE EMBODIMENTS

The disclosure will be further described by embodiments in conjunction with the accompanying drawings.

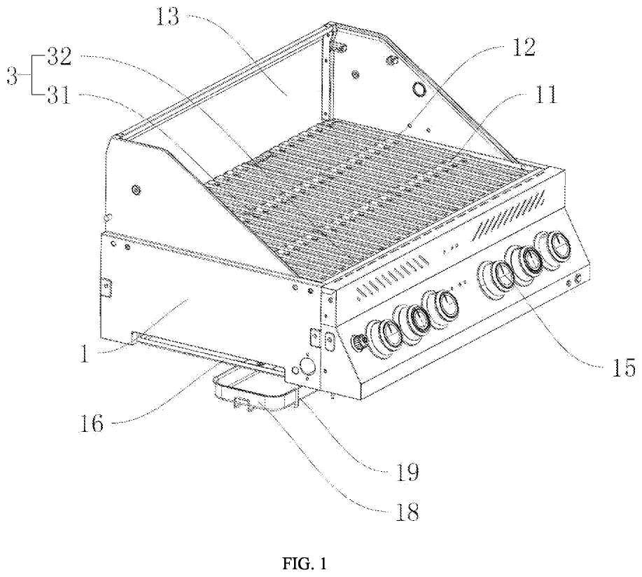

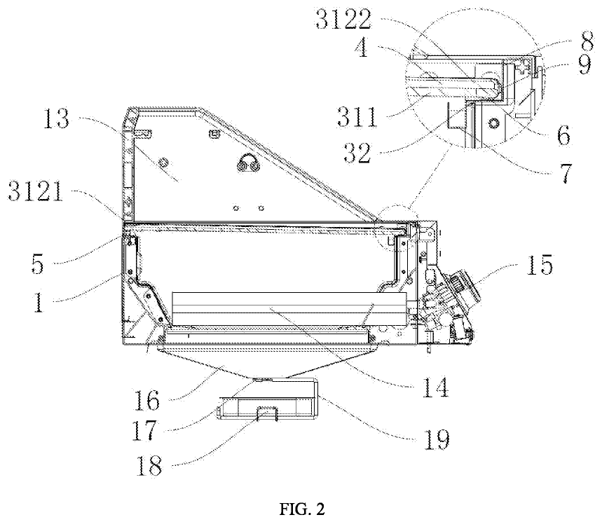

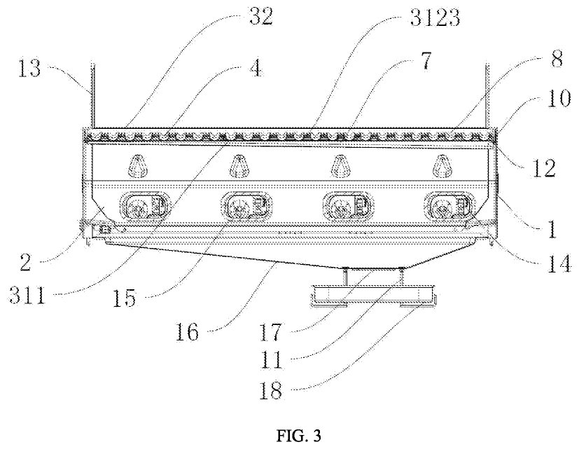

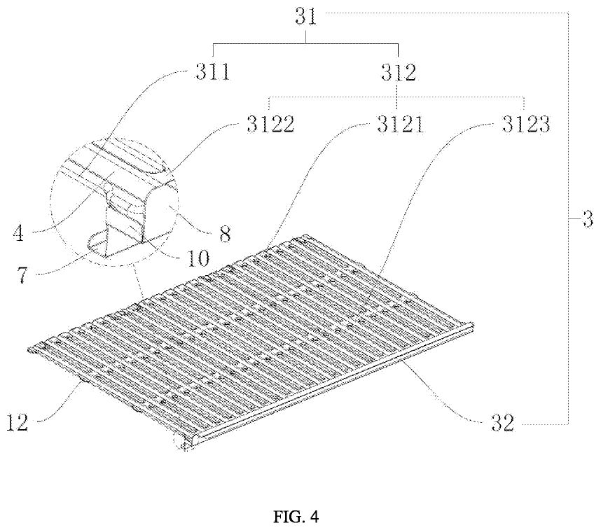

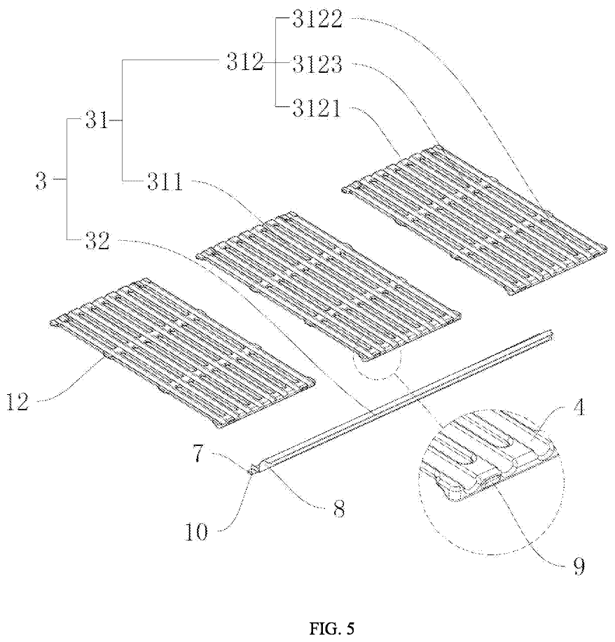

Referring to FIGS. 1 to 5, a food cooking device comprises a grill body 1 and a rack body 3, a food cooking cavity 2 is disposed in the grill body 1, and the rack body 3 is mounted in the food cooking cavity 2 and located below food being cooked, the rack body 3 comprises at least one net rack 31 and an oil collecting rack 32, totally three net racks 31 are provided, and the three neck racks 31 are arranged in a length direction of the oil collecting rack 32 and spliced on the oil collecting rack 32.

The net rack 31 comprises a plurality of bar-shaped pieces 311 disposed spaced from each other, the bar-shaped pieces 311 are respectively connected to each other by a connecting piece 312, the connecting piece 312 comprises a first connecting block 3123, a first support bar 3121 and a second support bar 3122, each of the first connecting blocks 3123 is fixedly connected with two corresponding adjacent bar-shaped pieces 311 respectively, the first connecting block 3123 can also be a bar-shaped structure, and the plurality of bar-shaped pieces 311 are uniformly distributed along a length direction of the first connecting block 3123 and are fixedly connected with the first connecting block 3123. The first support bar 3121 is formed on an end portion of the net rack 31 located at a position of one end of each of the bar-shaped pieces 311, at least one first cushion block 5 is formed on the first support bar 3121, a second support bar 3122 is formed on an end portion of the net rack 31 located at a position of the other end of each of the bar-shaped pieces 311, at least one second cushion block 6 is formed on the second support bar 3122, and the first support bar 3121 and the second support bar 3122 are integrally formed with two ends of each of the bar-shaped pieces 311 respectively. The connecting piece 312 serves to connect the plurality of bar-shaped pieces 311 into a plate-like structure for improving structural strength of the net rack 31. A side wall of each of the bar-shaped pieces 311 near an end portion of the first support bar 3121 is provided with a second connecting block 12 corresponding to a position of the first connecting block 3123, and when two adjacent net racks 31 are spliced, the second connecting block 12 at one side of the net rack 31 abuts against the second connecting block 12 at an opposite side of the adjacent net rack 31 so as to align and splice the two adjacent net racks 31.

A top surface of each of the bar-shaped pieces 311 is provided with an oil guiding groove 4 in a concave surface, the oil guiding groove 4 extends along a length direction of each of the bar-shaped pieces 311 to a top of the second support bar 3122, a bottom of the first support bar 3121 is symmetrically provided with two first cushion blocks 5, and the end portion of the net rack 31 located at the position of one end of each of the bar-shaped pieces 311 is erected on a first step surface on the food cooking cavity 2 by at least one first cushion block 5. A bottom of the second support bar 3122 is symmetrically provided with two second cushion blocks 6, the end portion of the net rack 31 located at the position of the other end of each of the bar-shaped members 311 is erected on a second step surface on the food cooking cavity 2 by at least one second cushion block 6, the first cushion block 5 and the second cushion block 6 have a height difference, and a height of the first cushion block 5 is higher than a height of the second cushion block 6 so that the net rack 31 is in an inclined state after being mounted in the food cooking cavity 2.

The second step surface on the food cooking cavity 2 is formed on the oil collecting rack 32, a bottom surface of the second cushion block 6 abuts against a top surface of the oil collecting rack 32, the net rack 31 mounted on the food cooking cavity 2 is inclined by the first cushion block 5 and the second cushion block 6, the first support bar 3121 is located at a higher position, and the second support bar 3122 is located at a lower position. When a user grills food on the net rack 31, grease on the net rack 31 flows to the first support bar 3121 under the guidance of the oil guiding groove 4, producing good oil guiding effect on the grease, preventing excess grease from dripping onto a heat source through the net rack 31, and to a certain extent, avoiding contamination of the food by oil smoke and improving barbecue experience of the user.

Both of the oil collecting rack 32 are provided with mounting plates 10 abutting against end portions of the second support bar 3122, so as to avoid multiple net racks 31 spliced together from shaking on the oil collecting rack 32; a baffle 8 is formed on the top surface of the oil collecting rack 32; and a side wall of the second support bars 3122 is provided with a spacer block 9 abutting against the baffle 8. The spacer block 9 abuts against the baffle 8, so that a gap for grease to pass through can be reserved, so that the grease flows to the baffle 8 along the oil guiding groove 4 and flows out through the gap. A bottom of the oil collecting rack 32 is provided with an oil collecting groove 7 disposed obliquely towards the net rack 31 for collecting the grease from lower parts of a plurality of oil guiding groove 4. The grease in the oil collecting groove 7 flows to a lower part of the oil collecting groove 7 along an inner groove wall of the oil collecting groove 7 by gravity.

A top surface of one side of the food cooking cavity 2 is used for mounting the first support bar 3121 and a top surface of the other side of the food cooking cavity 2 is used for mounting the second support bar 3122 to support the rack body 3. A grill head pipe 14 capable of spraying fire is disposed in the food cooking cavity 2, and the grill head pipe 14 is connected to a regulating valve 15 for controlling amount of the spraying fire of the grill head pipe 14 so as to facilitate the user to control the fire of barbecue according to needs. An enclosure plate 13 is disposed around the top of the grill body 1 so as to obstruct sundries from blowing into the net rack 31 with the wind; an oil collecting tray 16 in a conical structure is mounted at a bottom of the food cooking cavity 2; an oil outlet 17 is disposed through a bottom of the oil collecting tray 16; an oil collecting box 18 is mounted at a bottom of the oil outlet 17; and an opening of the oil collecting box 18 corresponds to the oil outlet 17. When the grease on the net rack 31 successively flows through the oil guiding groove 4, the oil collecting groove 7 and the food cooking cavity 2, the grease flows out from the oil outlet 17 along an inner wall of the oil collecting tray 16 and drips into the oil collecting box 18, a mounting rack 11 is fixed connected at a position of the oil collecting box 18 corresponding to the oil outlet, the oil collecting box 18 is detachably connected with the oil collecting box 18 by the mounting rack 11, and the user can remove the oil collecting box 18 and clear off collected grease to prepare for next use.

Of course, the above description merely illustrates typical examples of the disclosure. In addition, the disclosure can also have various other specific embodiments, and all the technical schemes formed by using the equivalent replacement or equivalent transformation fall within the scope of protection of the disclosure.

What is claimed is:

1. A food cooking device, comprising a grill body and a rack body, a food cooking cavity being disposed in the grill body, and the rack body being disposed in the food cooking cavity and located below food being cooked, wherein the rack body comprises at least one net rack, the net rack comprises a plurality of bar-shaped pieces disposed spaced from each other, the bar-shaped pieces are respectively connected to each other by a connecting piece, one side of each of the bar-shaped pieces facing the food being cooked is formed with an oil guiding groove extending along a length direction thereof, the net rack is obliquely mounted in the food cooking cavity so that the oil guiding groove on each of the bar-shaped pieces is in an inclined state, and two ends of the oil guiding groove form a height difference.

2. The food cooking device according to claim 1, wherein an end portion of the network rack located at a position of one end of each of the bar-shaped pieces is erected on a first step surface on the food cooking cavity by at least one first cushion block.

3. The food cooking device according to claim 2, wherein an end portion of the net rack located at a position of the other end of each of the bar-shaped pieces is erected on a second step surface on the food cooking cavity by at least one second cushion block, and the first cushion block and the second cushion block have a height difference so that the net rack is in an inclined state after being mounted in the food cooking cavity.

4. The food cooking device according to claim 3, wherein the connecting piece further comprises a first support bar, the first support bar is formed on the end portion of the net rack located at the position of one end of each of the bar-shaped pieces, and the at least one first block is formed on the first support bar.

5. The food cooking device according to claim 4, wherein the connecting piece further comprises a second support bar, the second support bar is formed on the end portion of the net rack located at the position of the other end of each of the bar-shaped pieces, and the at least one second cushion block is formed on the second support bar.

6. The food cooking device according to claim 1, wherein the connecting piece comprises a first connecting block, and the first connecting block is fixedly connected with two adjacent bar-shaped pieces.

7. The food cooking device according to claim 6, wherein an outer wall of the bar-shaped piece located at the outermost side is formed with a second connecting block, and a position of the second connecting block corresponds to a position of the first connecting block.

8. The food cooking device according to claim 5, wherein the grill body comprises an oil collecting rack for mounting the net rack, the second step surface is formed on the oil collecting rack, a height of the first cushion block is higher than a height of the second cushion block, and a bottom of the oil collecting rack is provided with an oil collecting groove disposed obliquely towards the net rack.

9. The food cooking device according to claim 8, wherein a baffle is formed on a top surface of the oil collecting rack, and a side wall of the second support bar is provided with a spacer block abutting against the baffle.

10. The food cooking device according to claim 9, wherein both sides of the oil collecting rack are provided with mounting plates abutting against end portions of the second support bar.
